(19) United States
(12) Patent Application Publication
(10) Pub. No.: US 2020/0063473 A1
(43) Pub. Date: Feb. 27, 2020

(54) TWO-PIECE DOORSTOPS

(71) Applicant: INTERNATIONAL SALES INC., Virginia Beach, VA (US)

(72) Inventor: Thomas G.B. MEREY, Port Hope (CA)

(21) Appl. No.: 16/549,001

(22) Filed: Aug. 23, 2019

(30) Foreign Application Priority Data
Aug. 23, 2018 (CA) 3015184

(51) Int. Cl. E05C 17/54

(52) U.S. Cl. CPC E05C 17/54

(57) ABSTRACT

The doorstop has upper and lower components. The upper component is wedge-shaped and is provided with a ramp which contacts a door. The lower component is in the form of a resilient and compressible pad. A downwardly facing wall of the pad rests on the floor beneath the door and has a coefficient of friction substantially greater than that of the ramp, such that the door slides substantially freely over the ramp while the downwardly facing wall of the pad resists sliding over the floor.

### CROSS-REFERENCE TO RELATED APPLICATIONS

This application claims priority to Canadian patent application no. 3,015,184, filed Aug. 23, 2018, the entirety of which is incorporated herein by reference.

### FIELD

The present disclosure relates to doorstops.

### BACKGROUND

Examples of conventional doorstops in common everyday use have two different basic shapes. One is shaped like a crescent or a waxing or waning moon and the other in the shape of a wedge. An example prior art doorstop is shown in FIGS. 10-12. The outer surface of the former doorstop has a low coefficient of friction in the area which touches the floor and as a door begins to close over the doorstop, the device begins to turn and immobilize the door as it is squeezed between the door and the floor. The latter doorstop is often composed of solid rubber of sufficient weight that its coefficient of friction alone causes it to remain stationary as it is squeezed between a door and the floor.

A disadvantage of a crescent shaped doorstop is that if a user wants to close the door when it is immobilized by the doorstop, he/she must bend over and remove the doorstop by hand. As for the other doorstop, a disadvantage is that it relies on its weight to provide the necessary friction to immobilize a door. The weight and hence the substantial size of the doorstop adds a significant amount to the overall cost.

### SUMMARY

Disclosed herein are doorstops that may be removed from between a door and the floor by a user's foot. There is no need for a user to stoop down to remove the doorstop by hand. Moreover, the weight of the device may be made significantly less than that of a conventional doorstop composed entirely of rubber or similar material, as described above.

The doorstops disclosed herein may be suited for use on a floor which has a substantially inflexible upper surface, such as a hardwood, linoleum, thermoplastic, or ceramic tile.

Briefly, an example doorstop is composed of two components, one in the shape of a wedge, the other in the shape of a flat pad. The two components are composed of materials with differing coefficients of friction. The wedge-shaped component has a relatively low coefficient of friction and can be made of hard plastic, a metal or other material which is not significantly distorted when under load. The other component is composed of material which has a higher coefficient of friction such as thermoplastic synthetic rubber.

The pad may be composed of nitrile butadiene rubber. Such material possesses a high degree of resistance to sliding on a floor composed of substantially inflexible material such as plastic or rubber. Such material resists movement even with minimal downward pressure by a door. The resistance to movement of the material may be further enhanced by a pattern of recesses formed in it.

### BRIEF DESCRIPTION OF THE DRAWINGS

The doorstops disclosed herein are described in detail with reference to the accompanying drawings, in which like reference numerals denote like parts or components.

FIG. 1 is a plan view of an example doorstop according to this disclosure.

FIG. 2 is an elevation view of the doorstop of FIG. 1.

FIG. 3 is a perspective view of the doorstop of FIG. 1.

FIG. 4 is a view of the lower or downwardly facing wall of an example doorstop according to this disclosure.

FIG. 5 is an elevation view of the lower wall of FIG. 4, facing upward.

FIG. 6 is perspective view of the lower wall of FIG. 4, facing upward;

FIG. 7 is an elevation view of an example doorstop according to this disclosure in conjunction with an elevation of a side wall of a door.

FIG. 8 is a fragmentary elevation view of a pad of the doorstop of FIG. 7.

FIG. 9 is a perspective view of the doorstop of FIG. 7 in conjunction with a perspective view of a door.

FIG. 10 is a plan view of a circular doorstop of the prior art.

FIG. 11 is an elevation of the doorstop of FIG. 10.

FIG. 12 is a perspective view of the doorstop of FIG. 10.

FIG. 13 is diagram showing operation of friction.

FIG. 14 is diagram showing operation of friction on an example doorstop according to this disclosure.

FIG. 15 is graph showing friction vs. normal force for an example doorstop according to this disclosure.

### DETAILED DESCRIPTION

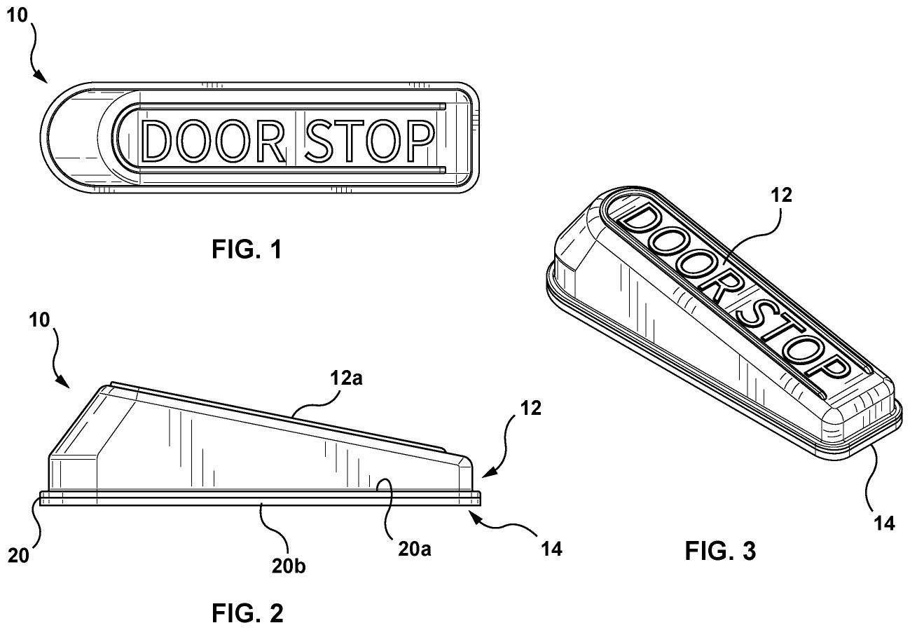

With reference to FIGS. 1-3, an example doorstop 10 includes an upper component 12 and a lower component 14. The upper component 12 is generally wedge shaped and may be made of plastic. A ramp 12a of the wedge offers little resistance to the door as the door slides over the ramp 12a, as is explained in greater detail below. The upper component 12 may include a side wall to support the ramp 12a and such side wall may be rectangular, circular, or a combination of such, as depicted.

The lower component 14 is in the form of a pad 20 of resilient and compressible material which rests on the floor beneath the door. The pad 20 may be composed of a soft thermoplastic synthetic rubber, such as nitrile butadiene rubber. The coefficient of friction of a lower or downwardly facing wall 20b of the pad 20 is in the range of about 1.3 to about 1.6, such as about 1.5.

An upper wall 20a of the pad 20 is attached to the upper component or wedge 12 by, for example, an adhesive. The lower wall 20b of the pad 20 is to contact the floor.

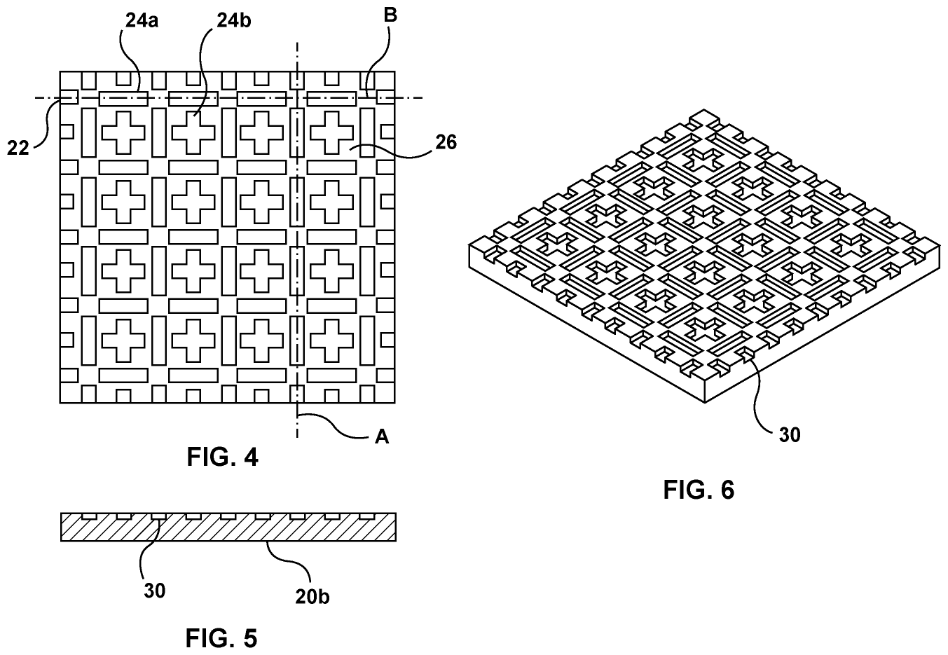

With reference to FIG. 4, the lower wall 20b of the pad 20 is provided with a number of downwardly opening recesses 22, 24. Recesses 22 may be located at a periphery of the pad 20. Other recesses 24 may be located at the interior of the pad 20. The recesses 22, 24 function to facilitate the compression of the pad 20 under the pressure of the door on the ramp 12a. The recesses 24 in the interior may include straight segments 24a and cross-shaped segments 24b. The straight segments 24a may be arranged in parallel longitudinally extending rows A and laterally extending rows B. Four recesses 24a in adjacent rows define a square 26, in which a cross-shaped recess 24b may be located.

With reference to FIGS. 5 and 6, each recess 22, 24 extends upwardly into the interior of the pad from the lower, or downwardly facing, wall 20b and is defined by an interior wall 30.

With reference to FIG. 8, the interior wall 30 descends resiliently into contact with floor 40 when the door applies a downward force onto the doorstop. A portion 30a of the interior wall 30 contacts the floor 40 and increases the area of contact of the lower wall 20b of the pad with the floor 40.

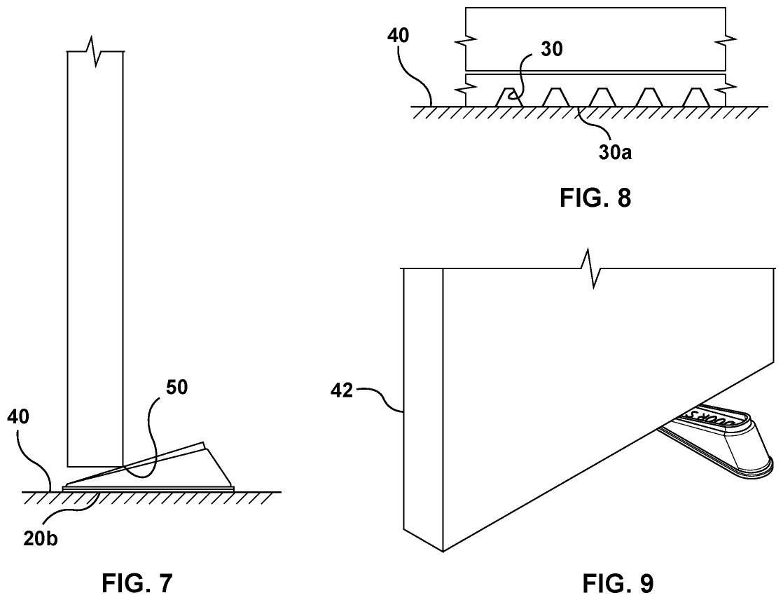

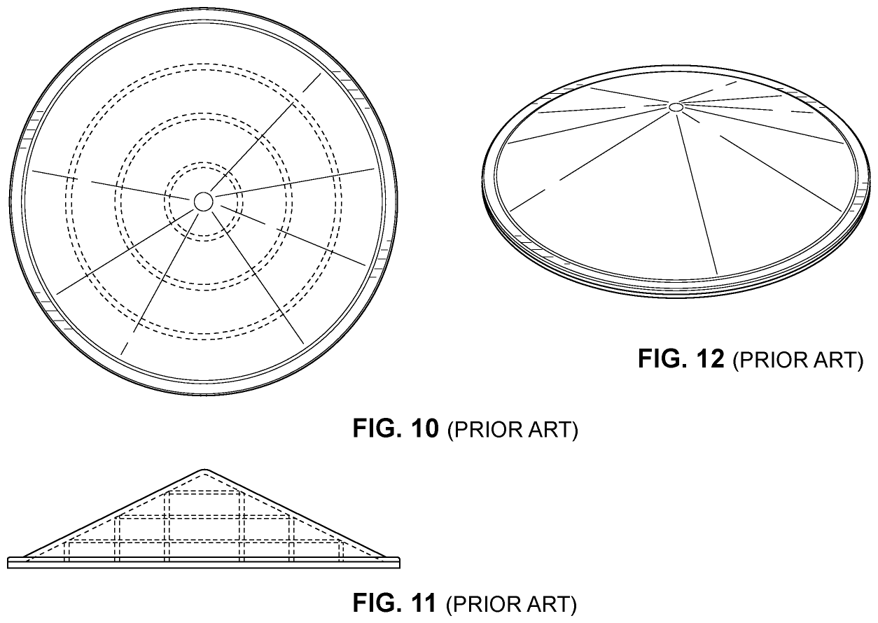

With reference to FIG. 7, at the threshold of contact 50 between the door and ramp of the doorstop one of two things may happen: either (a) the friction between the lower wall of the doorstop and the floor is not sufficient to prevent the door from pushing the doorstop forward; or (b) there is sufficient friction to immobilize the doorstop on the floor. In the former case (a), the doorstop must be immobilized by a user's foot to disengage the doorstop from the door. In the latter case (b), the door encounters low friction on the ramp of the doorstop and travels slightly forward up the ramp thereby compressing the pad of the doorstop against the floor. The pad compresses just enough to create the friction necessary to immobilize the doorstop. Further forward movement of the door causes the friction between the pad and the floor to increase as the pressure of walls 30a of the recesses on the floor increase. In this case, no intervention of a foot is required and the doorstop is immobilized. This is the desirable outcome.

When the door is being closed, pressure of the doorstop on the floor decreases thereby allowing the door to close. This operation requires low friction between the door and the ramp and high friction between the doorstop and the floor so that the doorstop remains stationary while the door disengages from the ramp. Hence, the feature of low/high friction of the present doorstop 10 facilitates both the engaging and disengaging operations and is achieved by the use of two dissimilar materials having different coefficients of friction.

For the sake of reducing the cost of the pad, it may be made no thicker than is necessary for the portion 30a of the interior wall to make contact with the floor. In this regard, the thickness of the pad may be about 2.25 mm.

The coefficient of friction of ramp 12a is significantly less than the coefficient of friction of the lower wall 20b of the pad. The coefficient of friction of ramp 12a may be in the range of 0.35 to 0.55 while the coefficient of friction of the lower wall 20b, as set out above, may be in the range of 1.3 to 1.6. As previously indicated, movement of the doorstop is impeded or prevented altogether as the door opens and closes by the low friction of the ramp as the door slides across it and by the high friction of the pad. The doorstop should preferably stand still as the door is opened and closed and the differing coefficients of friction encourage or cause this to occur.

The following describes the features of the doorstop and its operation in detail. As indicated above, a doorstop of this disclosure is composed of two materials. The wedge-shaped main body or upper component can be made of a relatively hard plastic so that the wedge shape is not distorted under load. The pad beneath the hard-plastic wedge is composed of a soft material with a high frictional characteristic under very low, even minimal downward pressure. This unusual characteristic is created due to the softness of the material itself and by the pattern of recesses in its lower or downwardly facing wall.

As a door begins to close and the wedge is placed such that its thin end faces the gap between the door and the floor, the following occurs: (i) the light-weight wedge has an initial resistance to the sliding displacement due to the high frictional patterned interface with the floor; (ii) this initial high friction tends to hold the doorstop in place as the bottom wall of the door travels up the slope of the doorstop and begins to apply some downward pressure on the doorstop, (iii) because of the downward pressure, the pad begins to compress against the floor with resulting enlargement of the surface of the lower wall of the pad in contact with the floor resulting from filling in of the gaps in the lower wall. Because of the additional surface area of the lower wall against the floor, the coefficient of friction between the lower wall and the floor increases.

The recesses in the lower wall augments the effectiveness of the lower wall to hinder movement of the doorstop on the floor. If the lower wall lacked the recesses, the pad would not compress as readily. On a slippery floor, the door might simply cause the doorstop to move as the door moves.

A coefficient of friction was calculated for a number of doorstops using the formula, as set out below.

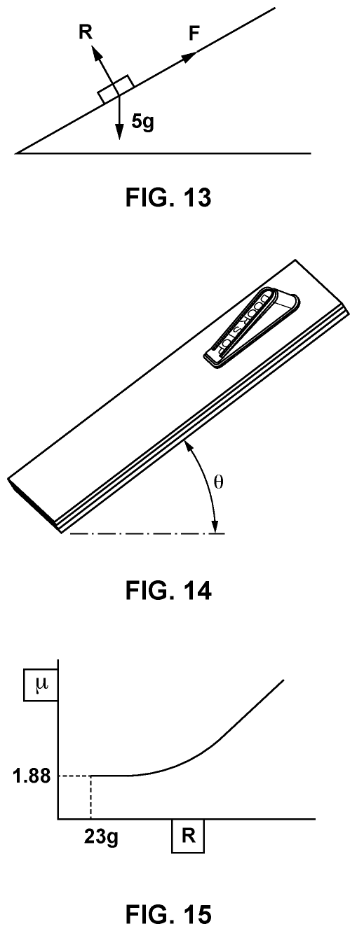

With reference to FIG. 13, the coefficient of friction is given by t=F/R, where F is the frictional force that acts parallel to the surfaces in contact, in a direction opposite potential motion. In the example shown, if a 5-gram object is placed on a 30 degree incline in a state of equilibrium on the threshold of sliding, then F=5 g sin(30).

Considering perpendicular to the plane of sliding, R=5 g cos(30). Hence, μ=sin(30)/cos(30)=tan(30). Generally, the coefficient of static friction, μ, may be considered the tangent of the angle of the incline at which the object begins to slide. This relationship was used to verify the coefficient of friction for a number of doorstops on the market using the test apparatus shown in FIG. 14.

A length of oak floorboard was tilted at increasing angles to the horizontal plane until the object under test reached the threshold of sliding down. The angle of the board with respect to horizontal plane was measured and the coefficient of friction was calculated as μ=tan(θ). The results obtained are summarized in Table 1 below.

TABLE 1

| | Threshold angle | μ |
|---|---|---|
| Object | (degrees) | (initial) |
| Doorstop A | 15 | 0.27 |
| Doorstop B | 23 | 0.42 |
| Doorstop C | 25 | 0.46 |
| Doorstop D | 21 | 0.38 |
| Doorstop 10 as described herein | 62 | 1.88 |

The tested doorstop 10 tested had a mass of 23 grams. The coefficient of friction was measured to be significant at 1.88.

The doorstop 10 was further tested by placing it on a horizontal oak floorboard. The doorstop was 25 grams and the initial coefficient of friction was as above, 1.88 A string was attached to the doorstop 10 and the string was run though a pully so that weights could be hung from its free end. Weight was added to the string to pull the doorstop 10 forward to measure friction force F. Weights were also added in 2-gram increments on top of the doorstop 10 to simulate the engagement of downward force from a door as force R. The change in coefficient of friction, μ, was measured and plotted over a range of forces R, as shown in FIG. 15. As can be seen, coefficient of friction of the doorstop 10 increases nonlinearly (e.g., exponentially) with increased force from door engagement. As such, the doorstop 10 provides increased resistance to sliding as door force increases, which is a desirable trait in a doorstop.

It should be recognized that features and aspects of the various examples provided above can be combined into further examples that also fall within the scope of the present disclosure.

I claim:

1. A doorstop comprising
an upper component to contact a door, the upper component including a substantially inflexible ramp including an upper wall adapted to contact the door; and
a lower component to contact a floor, the lower component disposed beneath the upper component with respect to the door, the lower component including a resilient and compressible pad that includes a lower downwardly facing wall adapted to rest on the floor, a coefficient of friction of the downwardly facing wall being substantially greater than a coefficient of friction of substantially inflexible ramp, such that the door slides substantially freely over the substantially inflexible ramp while the lower wall resists sliding on the floor.

2. The doorstop of claim 1 wherein the coefficient of friction of the lower downwardly facing wall is greater than about 1.5.

3. The doorstop of claim 2, wherein the coefficient of friction of the substantially inflexible ramp is between about 0.35 and about 0.55.

4. The doorstop of claim 1, wherein the lower downwardly facing wall includes a plurality of downwardly opening recesses defined by an interior wall.

5. The doorstop of claim 4, wherein at least a portion of the interior wall is to descend resiliently into contact with the floor when the door applies a downward force to the upper component.

6. The doorstop of claim 4, wherein the plurality of downwardly opening recesses is arranged in a high-friction pattern.

7. The doorstop of claim 4, wherein coefficient of friction of the downwardly facing wall increases nonlinearly with increasing downward force applied to the upper component by the door.

8. The doorstop of claim 4, wherein the plurality of downwardly opening recesses is arranged in rows.

9. The doorstop of claim 4, wherein the plurality of downwardly opening recesses includes recesses shaped as straight segments and recesses shaped as cross-shaped segments.

10. The doorstop of claim 9, wherein a recess shaped as cross-shaped segments is surrounded by arrangement of recesses shaped as straight segments.

11. The doorstop of claim 1, wherein the resilient and compressible pad is composed of nitrile butadiene rubber.

12. The doorstop of claim 1 wherein the upper component includes a rectangular side wall.

13. The doorstop of claim 1 wherein the upper component includes a circular side wall.
